(19) United States
(12) Patent Application Publication
(10) Pub. No.: US 2015/0158275 A1
(43) Pub. Date: Jun. 11, 2015

(54) NON-YELLOWING GLASS LAMINATE STRUCTURE

(71) Applicant: CORNING INCORPORATED, CORNING, NY (US)

(72) Inventors: John Joseph D'Errico, Glastonbury, CT (US); William Keith Fisher, Suffield, CT (US); Mark Stephen Friske, Campbell, NY (US)

(21) Appl. No.: 14/559,345

(22) Filed: Dec. 3, 2014

Related U.S. Application Data
(60) Provisional application No. 61/914,144, filed on Dec. 10, 2013.

(51) Int. Cl. B32B 17/10

(52) U.S. Cl. CPC B32B 17/10678; B32B 17/10036; B32B 17/10091; B32B 17/10137; B32B 17/10761; B32B 2307/412; B32B 2605/08

(57) ABSTRACT

A glass laminate structure comprising an internal glass sheet, an external glass sheet, and at least one polymer interlayer intermediate the external and internal glass sheets where the polymer interlayer includes a phenol, 2-(2H-benzotriazol-2-yl)-4,6-bis(1,1-dimethylpropyl) additive, a 2-(2H-benzotriazol-2-yl)-4,6-bis(1-methyl-1-phenylethyl)phenol additive, a 2-(2H-Benzotriazol-2-yl)-6-(1-methyl-1-phenylethyl)-4-(1,1,3,3-tetramethylbutyl)phenol additive, or an hydroxyphenyl substituted benzotriazole additive without a chlorine substituent. In some embodiments, the external and/or internal glass sheets can be formed from non-chemically strengthened glass, and in other embodiments, the external and/or internal glass sheets can be formed from chemically strengthened glass. Use of such an additive can reduce or eliminate discoloration of the polymer interlayer when using high ultraviolet transmission glass sheets.

### RELATED APPLICATIONS

The instant application claims the priority benefit of co-pending U.S. Provisional Application No. 61/914,144 filed Dec. 10, 2013, the entirety of which is incorporated herein by reference.

### BACKGROUND

The present disclosure relates generally to glass laminates comprising one or more chemically-strengthened glass panes. Glass laminates can be used as windows and glazing in architectural and vehicle or transportation applications, including automobiles, rolling stock, locomotive and airplanes. Glass laminates can also be used as glass panels in balustrades and stairs, and as decorative panels or coverings for walls, columns, elevator cabs, kitchen appliances and other applications. As used herein, a glazing, laminate, laminate structure or a laminated glass structure can be a transparent, semi-transparent, translucent or opaque part of a window, panel, wall, enclosure, sign or other structure. Common types of glazings that are used in architectural and/or vehicular applications include clear and tinted laminated glass structures.

In some laminate structures having high ultraviolet (UV) transmission glass sheets, e.g., Corning Gorilla® Glass, PPG Starphire® Glass, etc., conventional polymeric interlayer materials can discolor or yellow after extended exposure to sunlight or other UV light sources. Laminate structures using conventional soda lime glass also discolor or yellow but at a much lower rate due to the lower UV light transmission provided by soda lime glass. Thus, there is a need to provide a non-yellowing glass laminate structure.

### SUMMARY

The glass laminates disclosed herein are configured to include one or more panes of high ultraviolet transmission glass. In some embodiments, one or both of these panes can be chemically-strengthened glass panes. Other embodiments of the present disclosure include a chemically-strengthened outer glass pane and a non-chemically-strengthened inner glass pane. Additional embodiments of the present disclosure include a chemically-strengthened inner glass pane and a non-chemically-strengthened outer glass pane. Further embodiments of the present disclosure include chemically-strengthened outer and inner glass panes. Yet additional embodiments of the present disclosure include inner and outer glass panes which are non-chemically strengthened. As defined herein, when the glass laminates are put into use, an external glass sheet will be proximate to or in contact with the environment, while an internal glass sheet will be proximate to or in contact with the interior (e.g., cabin) of the structure or vehicle (e.g., automobile) incorporating the glass laminate.

According to some embodiments of the present disclosure, a glass laminate can comprise an external glass sheet, an internal glass sheet, and a polymer interlayer formed between the external and internal glass sheets. To optimize the impact behavior of the glass laminate, the external glass sheet can comprise chemically-strengthened glass and can have a thickness of less than or equal to 1 mm, while the internal glass sheet can comprise non-chemically-strengthened glass and can have a thickness of less than or equal to 2.5 mm or greater than 2.5 mm, e.g., 5 mm to 15 mm, 7 mm to 12 mm, etc. In other embodiments, the polymer interlayer (e.g., poly(vinyl butyral) or PVB) can have a thickness of less than or equal to 1.6 mm, or greater than 1.6 mm, e.g., 1.6 mm to 3 mm, 2.0 mm to 2.3 mm, etc. The disclosed glass laminate structures can advantageously distribute stresses in response to an impact. For example, the disclosed glass laminate structures can provide superior impact resistance and resist breakage in response to external impact events, yet appropriately dissipate energy and appropriately fracture in response to internal impact events. In other embodiments, the interlayer material can include an additive that inhibits UV light-induced chemical reactions from occurring which would otherwise result in discoloration of the interlayer material. In some embodiments, the additive includes, but is not limited to, phenol, 2-(2H-benzotriazol-2-yl)-4,6-bis(1,1-dimethylpropyl), 2-(2H-benzotriazole-2-yl)-4,6-ditertpentyl phenol, a 2-(2H-benzotriazol-2-yl)-4,6-bis(1-methyl-1-phenylethyl)phenol, 2-(2H-Benzotriazol-2-yl)-6-(1-methyl-1-phenylethyl)-4-(1,1,3,3-tetramethylbutyl)phenol, hydroxyphenyl substituted benzotriazole additive without a chlorine substituent, and the like.

In some embodiments of the present disclosure a glass laminate structure is provided having a non-chemically strengthened external glass sheet, a chemically strengthened internal glass sheet, and at least one polymer interlayer intermediate the external and internal glass sheets. The polymer interlayer can include a phenol, 2-(2H-benzotriazol-2-yl)-4,6-bis(1,1-dimethylpropyl), a 2-(2H-benzotriazol-2-yl)-4,6-bis(1-methyl-1-phenylethyl)phenol additive, a 2-(2H-Benzotriazol-2-yl)-6-(1-methyl-1-phenylethyl)-4-(1,1,3,3-tetramethylbutyl)phenol additive, or an hydroxyphenyl substituted benzotriazole additive without a chlorine substituent.

In other embodiments of the present disclosure a glass laminate structure is provided having a non-chemically strengthened internal glass sheet, a chemically strengthened external glass sheet, and at least one polymer interlayer intermediate the external and internal glass sheets. The polymer interlayer can include a phenol, 2-(2H-benzotriazol-2-yl)-4,6-bis(1,1-dimethylpropyl), a 2-(2H-benzotriazol-2-yl)-4,6-bis(1-methyl-1-phenylethyl)phenol additive, a 2-(2H-Benzotriazol-2-yl)-6-(1-methyl-1-phenylethyl)-4-(1,1,3,3-tetramethylbutyl)phenol additive, or an hydroxyphenyl substituted benzotriazole additive without a chlorine substituent.

In further embodiments of the present disclosure a glass laminate structure is provided having an internal glass sheet, an external glass sheet, and at least one polymer interlayer intermediate the external and internal glass sheets. The polymer interlayer can include a phenol, 2-(2H-benzotriazol-2-yl)-4,6-bis(1,1-dimethylpropyl), a 2-(2H-benzotriazol-2-yl)-4,6-bis(1-methyl-1-phenylethyl)phenol additive, a 2-(2H-Benzotriazol-2-yl)-6-(1-methyl-1-phenylethyl)-4-(1,1,3,3-tetramethylbutyl)phenol additive, or an hydroxyphenyl substituted benzotriazole additive without a chlorine substituent.

It should be noted that embodiments of the present subject matter are applicable to high ultraviolet transmission glass sheets. Thus, while references herein may be made herein to chemically strengthened or non-chemically strengthened glass, such references should not limit the scope of the claims appended herewith as each of these exemplary embodiments are merely species of the high UV transmission genus.

Additional features and advantages of the claimed subject matter will be set forth in the detailed description which follows, and in part will be readily apparent to those skilled in the art from that description or recognized by practicing the claimed subject matter as described herein, including the detailed description which follows, the claims, as well as the appended drawings.

It is to be understood that both the foregoing general description and the following detailed description present embodiments of the present disclosure, and are intended to provide an overview or framework for understanding the nature and character of the claimed subject matter. The accompanying drawings are included to provide a further understanding of the present disclosure, and are incorporated into and constitute a part of this specification. The drawings illustrate various embodiments and together with the description serve to explain the principles and operations of the claimed subject matter.

### BRIEF DESCRIPTION OF THE DRAWINGS

For the purposes of illustration, there are forms shown in the drawings that are presently preferred, it being understood, however, that the embodiments disclosed and discussed herein are not limited to the precise arrangements and instrumentalities shown.

FIG. 1 is a schematic of an exemplary planar glass laminate structure according to some embodiments of the present disclosure.

FIG. 2 is a plot comparing UV transmissions of standard soda lime glass and high UV transmission, chemically strengthened glass.

FIG. 3 is a schematic of an exemplary bent glass laminate structure according to other embodiments of the present disclosure.

FIG. 4 is a schematic of an exemplary bent glass laminate structure according to further embodiments of the present disclosure.

FIG. 5 is a schematic of an exemplary bent glass laminate structure according to additional embodiments of the present disclosure.

FIG. 6 is a plot comparing transmissions of yellowness index versus exposure of other embodiments of the present disclosure.

FIG. 7 is a plot comparing transmission values of some embodiments of the present disclosure.

### DETAILED DESCRIPTION

In the following description, like reference characters designate like or corresponding parts throughout the several views shown in the figures. It is also understood that, unless otherwise specified, terms such as “top,” “bottom,” “outward,” “inward,” and the like are words of convenience and are not to be construed as limiting terms. In addition, whenever a group is described as comprising at least one of a group of elements and combinations thereof, it is understood that the group may comprise, consist essentially of, or consist of any number of those elements recited, either individually or in combination with each other.

Unless otherwise specified, a range of values, when recited, includes both the upper and lower limits of the range. As used herein, the indefinite articles “a,” and “an,” and the corresponding definite article “the” mean “at least one” or “one or more,” unless otherwise specified.

The following description of the present disclosure is provided as an enabling teaching thereof and its best, currently-known embodiment. Those skilled in the art will recognize that many changes can be made to the embodiment described herein while still obtaining the beneficial results of the present disclosure. It will also be apparent that some of the desired benefits of the present disclosure can be obtained by selecting some of the features of the present disclosure without utilizing other features. Accordingly, those who work in the art will recognize that many modifications and adaptations of the present disclosure are possible and may even be desirable in certain circumstances and are part of the present disclosure. Thus, the following description is provided as illustrative of the principles of the present disclosure and not in limitation thereof.

The glass laminates disclosed herein are configured to include one or more panes of high ultraviolet transmission glass. In some embodiments, one or both of these panes can be chemically-strengthened glass panes. Other embodiments of the present disclosure include a chemically-strengthened outer glass pane and a non-chemically-strengthened inner glass pane. Further embodiments of the present disclosure include a chemically-strengthened inner glass pane and a non-chemically-strengthened outer glass pane. Additional embodiments of the present disclosure include chemically-strengthened outer and inner glass panes. Yet additional embodiments of the present disclosure include inner and outer glass panes which are non-chemically strengthened. As defined herein, when the glass laminates are put into use, an external glass sheet will be proximate to or in contact with the environment, while an internal glass sheet will be proximate to or in contact with the interior (e.g., cabin) of the structure or vehicle (e.g., automobile) incorporating the glass laminate.

As noted above, embodiments of the present subject matter are applicable to high ultraviolet transmission glass sheets. Thus, while references herein may be made to chemically strengthened or non-chemically strengthened glass, such references should not limit the scope of the claims appended herewith as each of these examples are merely species of the high UV transmission genus.

Some embodiments include the application of one or more processes for producing a relatively thin glass sheet (on the order of about 2 mm or less) having certain characteristics, such as compressive stress (CS), relatively high depth of compressive layer (DOL), and/or moderate central tension (CT). The process includes preparing a glass sheet capable of ion exchange which can then be subjected to an ion exchange process. This ion exchanged glass sheet can then be subjected to an annealing process for some embodiments or an acid etching process for other embodiments or both.

An exemplary, non-limiting ion exchange process can involve subjecting the glass sheet to a molten salt bath including KNO₃, preferably relatively pure KNO₃ for one or more first temperatures within the range of about 400-500° C. and/or for a first time period within the range of about 1-24 hours, such as, but not limited to, about 8 hours. It is noted that other salt bath compositions are possible and would be within the skill level of an artisan to consider such alternatives. Thus, the disclosure of KNO₃ should not limit the scope of the claims appended herewith. Such an exemplary ion exchange process can produce an initial compressive stress (iCS) at the surface of the glass sheet, an initial depth of compressive layer (iDOL) into the glass sheet, and an initial central tension (iCT) within the glass sheet.

In general, after an exemplary ion exchange process, the initial compressive stress (iCS) can exceed a predetermined (or desired) value, such as being at or greater than about 500 MPa, and can typically reach 600 MPa or higher, or even reach 1000 MPa or higher in some glasses and under some processing profiles. Alternatively, after an exemplary ion exchange process, initial depth of compressive layer (iDOL) can be below a predetermined (or desired) value, such as being at or less than about 75 μm or even lower in some glasses and under some processing profiles. Alternatively, after an exemplary ion exchange process, initial central tension (iCT) can exceed a predetermined (or desired) value, such as above a predetermined frangibility limit of the glass sheet, which can be at or above about 40 MPa, or more particularly at or above about 48 MPa in some glasses.

If the initial compressive stress (iCS) exceeds a desired value, initial depth of compressive layer (iDOL) is below a desired value, and/or initial central tension (iCT) exceeds a desired value, this can lead to undesirable characteristics in a final product made using the respective glass sheet. For example, if the initial compressive stress (iCS) exceeds a desired value (reaching for example, 1000 MPa), then fracture of the glass under certain circumstances might not occur. Although this may be counter-intuitive, in some circumstances the glass sheet should be able to break, such as in an automotive glass application where the glass laminate structure must break at a certain impact load to prevent injury.

Further, if the initial depth of compressive layer (iDOL) is below a desired value, then under certain circumstances the glass sheet can break unexpectedly and under undesirable circumstances. Typical ion exchange processes can result in an initial depth of compressive layer (iDOL) being no more than about 40-60 μm, which can be less than the depth of scratches, pits, etc., developed in the glass sheet during use. For example, it has been discovered that installed automotive glazing (using ion exchanged glass) can develop external scratches reaching as deep as about 75 μm or more due to exposure to abrasive materials such as silica sand, flying debris, etc., within the environment in which the glass sheet is used. This depth can exceed the typical depth of compressive layer, which can lead to the glass unexpectedly fracturing during use.

Finally, if the initial central tension (iCT) exceeds a desired value, such as reaching or exceeding a chosen frangibility limit of the glass, then the glass sheet can break unexpectedly and under undesirable circumstances. For example, it has been discovered that a 4 inch×4 inch×0.7 mm sheet of Corning Gorilla® Glass exhibits performance characteristics in which undesirable fragmentation (energetic failure into a large number of small pieces when broken) occurs when a long single step ion exchange process (8 hours at 475° C.) was performed in pure KNO₃. Although a DOL of about 101 μm was achieved, a relatively high CT of 65 MPa resulted, which was higher than the chosen frangibility limit (48 MPa) of the subject glass sheet.

In the non-limiting embodiments in which an anneal is required, after the glass sheet has been subjected to ion exchange, the glass sheet can be subjected to an annealing process by elevating the glass sheet to one or more second temperatures for a second period of time. For example, the annealing process can be carried out in an air environment, can be performed at second temperatures within the range of about 400-500° C., and can be performed in a second time period within the range of about 4-24 hours, such as, but not limited to, about 8 hours. The annealing process can thus cause at least one of the initial compressive stress (iCS), the initial depth of compressive layer (iDOL), and the initial central tension (iCT) to be modified.

For example, after the annealing process, the initial compressive stress (iCS) can be reduced to a final compressive stress (fCS) which is at or below a predetermined value. By way of example, the initial compressive stress (iCS) can be at or greater than about 500 MPa, but the final compressive stress (fCS) can be at or less than about 400 MPa, 350 MPa, or 300 MPa. It is noted that the target for the final compressive stress (fCS) can be a function of glass thickness as in thicker glass a lower fCS can be desirable, and in thinner glass a higher fCS can be tolerable.

Additionally, after the annealing process, the initial depth of compressive layer (iDOL) can be increased to a final depth of compressive layer (fDOL) at or above the predetermined value. By way of example, the initial depth of compressive layer (iDOL) can be at or less than about 75 μm, and the final depth of compressive layer (fDOL) can be at or above about 80 μm or 90 μm, such as 100 μm or more.

Alternatively, after the annealing process, the initial central tension (iCT) can be reduced to a final central tension (fCT) at or below the predetermined value. By way of example, the initial central tension (iCT) can be at or above a chosen frangibility limit of the glass sheet (such as between about 40-48 MPa), and the final central tension (fCT) can be below the chosen frangibility limit of the glass sheet. Additional examples for generating exemplary ion exchangeable glass structures are described in co-pending U.S. application Ser. No. 13/626,958, filed Sep. 26, 2012 and U.S. application Ser. No. 13/926,461, filed Jun. 25, 2013 the entirety of each being incorporated herein by reference.

As noted above the conditions of the ion exchange step and the annealing step can be adjusted to achieve a desired compressive stress at the glass surface (CS), depth of compressive layer (DOL), and central tension (CT). The ion exchange step can be carried out by immersion of the glass sheet into a molten salt bath for a predetermined period of time, where ions within the glass sheet at or near the surface thereof are exchanged for larger metal ions, for example, from the salt bath. By way of example, the molten salt bath can include KNO₃, the temperature of the molten salt bath can be within the range of about 400-500° C., and the predetermined time period can be within the range of about 1-24 hours, and preferably between about 2-8 hours. The incorporation of the larger ions into the glass strengthens the sheet by creating a compressive stress in a near surface region. A corresponding tensile stress can be induced within a central region of the glass sheet to balance the compressive stress.

By way of further example, sodium ions within the glass sheet can be replaced by potassium ions from the molten salt bath, though other alkali metal ions having a larger atomic radius, such as rubidium or cesium, can also replace smaller alkali metal ions in the glass. According to some embodiments, smaller alkali metal ions in the glass sheet can be replaced by Ag+ ions. Similarly, other alkali metal salts such as, but not limited to, sulfates, halides, and the like can be used in the ion exchange process.

The replacement of smaller ions by larger ions at a temperature below that at which the glass network can relax produces a distribution of ions across the surface of the glass sheet resulting in a stress profile. The larger volume of the incoming ion produces a compressive stress (CS) on the surface and tension (central tension, or CT) in the center region of the glass. The compressive stress is related to the central tension by the following approximate relationship:

$$CS = CT ( \frac{t - 2 DOL}{DOL} )$$

where t represents the total thickness of the glass sheet and DOL represents the depth of exchange, also referred to as depth of compressive layer.

Any number of specific glass compositions can be employed in producing the glass sheet. For example, ion-exchangeable glasses suitable for use in the embodiments herein include alkali aluminosilicate glasses or alkali aluminoborosilicate glasses, though other glass compositions are contemplated. As used herein, “ion exchangeable” means that a glass is capable of exchanging cations located at or near the surface of the glass with cations of the same valence that are either larger or smaller in size.

For example, a suitable glass composition comprises SiO₂, B₂O₃ and Na₂O, where (SiO₂+B₂O₃)≦66 mol. %, and Na₂O≧9 mol. %. In an embodiment, the glass sheets include at least 4 wt. % aluminum oxide or 4 wt. % zirconium oxide. In a further embodiment, a glass sheet includes one or more alkaline earth oxides, such that a content of alkaline earth oxides is at least 5 wt. %. Suitable glass compositions, in some embodiments, further comprise at least one of K₂O, MgO, and CaO. In a particular embodiment, the glass can comprise 61-75 mol. % SiO₂; 7-15 mol. % Al₂O₃; 0-12 mol. % B₂O₃; 9-21 mol. % Na₂O; 0-4 mol. % K₂O; 0-7 mol. % MgO; and 0-3 mol. % CaO.

A further exemplary glass composition suitable for forming hybrid glass laminates comprises: 60-70 mol. % SiO₂; 6-14 mol. % Al₂O₃; 0-15 mol. % B₂O₃; 0-15 mol. % Li₂O; 0-20 mol. % Na₂O; 0-10 mol. % K₂O; 0-8 mol. % MgO; 0-10 mol. % CaO; 0-5 mol. % ZrO₂; 0-1 mol. % SnO₂; 0-1 mol. % CeO₂; less than 50 ppm As₂O₃; and less than 50 ppm Sb₂O₃; where 12 mol. %≦(Li₂O+Na₂O+K₂O)≦20 mol. % and 0 mol. %≦(MgO+CaO)≦10 mol. %.

A still further exemplary glass composition comprises: 63.5-66.5 mol. % SiO₂; 8-12 mol. % Al₂O₃; 0-3 mol. % B₂O₃; 0-5 mol. % Li₂O; 8-18 mol. % Na₂O; 0-5 mol. % K₂O; 1-7 mol. % MgO; 0-2.5 mol. % CaO; 0-3 mol. % ZrO₂; 0.05-0.25 mol. % SnO₂; 0.05-0.5 mol. % CeO₂; less than 50 ppm As₂O₃; and less than 50 ppm Sb₂O₃; where 14 mol. %≦(Li₂O+Na₂O+K2O)≦18 mol. % and 2 mol. %≦(MgO+CaO)≦7 mol. %.

In another embodiment, an alkali aluminosilicate glass comprises, consists essentially of, or consists of: 61-75 mol. % SiO₂; 7-15 mol. % Al₂O₃; 0-12 mol. % B₂O₃; 9-21 mol. % Na₂O; 0-4 mol. % K₂O; 0-7 mol. % MgO; and 0-3 mol. % CaO.

In a particular embodiment, an alkali aluminosilicate glass comprises alumina, at least one alkali metal and, in some embodiments, greater than 50 mol. % SiO₂, in other embodiments at least 58 mol. % SiO₂, and in still other embodiments at least 60 mol. % SiO₂, wherein the ratio

$$\frac{{Al}_{2} {O}_{3} + {B}_{2} {O}_{3}}{\sum modifiers} > 1 ,$$

where in the ratio the components are expressed in mol. % and the modifiers are alkali metal oxides. This glass, in particular embodiments, comprises, consists essentially of, or consists of: 58-72 mol. % SiO₂; 9-17 mol. % Al₂O₃; 2-12 mol. % B₂O₃; 8-16 mol. % Na₂O; and 0-4 mol. % K₂O, wherein the ratio

$$\frac{{Al}_{2} {O}_{3} + {B}_{2} {O}_{3}}{\sum modifiers} > 1.$$

In yet another embodiment, an alkali aluminosilicate glass substrate comprises, consists essentially of, or consists of: 60-70 mol. % SiO₂; 6-14 mol. % Al₂O₃; 0-15 mol. % B₂O₃; 0-15 mol. % Li₂O; 0-20 mol. % Na₂O; 0-10 mol. % K₂O; 0-8 mol. % MgO; 0-10 mol. % CaO; 0-5 mol. % ZrO₂; 0-1 mol. % SnO₂; 0-1 mol. % CeO₂; less than 50 ppm As₂O₃; and less than 50 ppm Sb₂O₃; wherein 12 mol. %≦Li₂O+Na₂O+K₂O≦20 mol. % and 0 mol. %≦MgO+CaO≦10 mol. %.

In still another embodiment, an alkali aluminosilicate glass comprises, consists essentially of, or consists of: 64-68 mol. % SiO₂; 12-16 mol. % Na₂O; 8-12 mol. % Al₂O₃; 0-3 mol. % B₂O₃; 2-5 mol. % K₂O; 4-6 mol. % MgO; and 0-5 mol. % CaO, wherein: 66 mol. %≦SiO₂+B₂O₃+CaO≦69 mol. %; Na₂O+K₂O+B₂O₃+MgO+CaO+SrO>10 mol. %; 5 mol. %≦MgO+CaO+SrO≦8 mol. %; (Na₂O+B₂O₃)≦Al₂O₃≦2 mol. %; 2 mol. %≦Na₂O≦Al₂O₃≦6 mol. %; and 4 mol. %≦(Na₂O+K₂O)≦Al₂O₃≦10 mol. %. Additional compositions of exemplary glass structures are described in co-pending U.S. application Ser. No. 13/626,958, filed Sep. 26, 2012 and U.S. application Ser. No. 13/926,461, filed Jun. 25, 2013 the entirety of each being incorporated herein by reference.

The processes described herein can be suitable for a range of applications. One application of particular interest can be, but is not limited to, automotive glazing applications, whereby the process enables production of glass which can pass automotive impact safety standards. Other applications can be identified by those knowledgeable in the art.

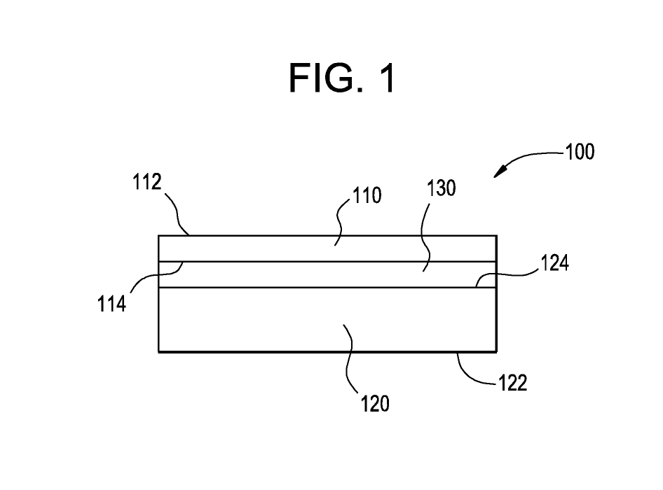

FIG. 1 is a cross-sectional illustration of one embodiment of the present disclosure. With reference to FIG. 1, an exemplary glass laminate structure 100 comprises an external glass sheet 110, an internal glass sheet 120, and a polymer interlayer 130. The polymer interlayer can be in direct physical contact (e.g., laminated to) each of the respective external and internal glass sheets. The external glass sheet 110 has an exterior surface 112 and an interior surface 114. In a similar vein, the internal glass sheet 120 has an exterior surface 122 and an interior surface 124. As shown in the illustrated embodiment, the interior surface 114 of external glass sheet 110 and the interior surface 124 of internal glass sheet 120 are each in contact with polymer interlayer 130. Any one, both or none of the glass sheets 110, 120 can be high UV transmission glass or high UV transmission, chemically strengthened glass.

In some embodiments, it can be desirable that the glass laminate structure resists fracture in response to external impact events. In response to internal impact events, however, such as the glass laminate structure being struck by a vehicle's occupant, it can be desirable that the glass laminate retain the occupant in the vehicle yet dissipate energy upon impact in order to minimize injury. The ECE R43 headform test, which simulates impact events occurring from inside a vehicle, is a regulatory test that requires that laminated glazings fracture in response to specified internal impact.

Without wishing to be bound by theory, when one pane of a glass sheet/polymer interlayer/glass sheet laminate is impacted, the opposite surface of the impacted sheet, as well as the exterior surface of the opposing sheet are placed into tension. Calculated stress distributions for a glass sheet/polymer interlayer/glass sheet laminate under biaxial loading reveal that the magnitude of tensile stress in the opposite surface of the impacted sheet may be comparable to (or even slightly greater than) the magnitude of the tensile stress experienced at the exterior surface of the opposing sheet for low loading rates. However, for high loading rates, which are characteristic of impacts typically experienced in automobiles, the magnitude of the tensile stress at the exterior surface of the opposing sheet may be much greater than the tensile stress at the opposite surface of the impacted sheet. As disclosed herein, by configuring the hybrid glass laminates to have a chemically-strengthened external glass sheet and a non-chemically-strengthened internal glass sheet, the impact resistance for both external and internal impact events can be optimized.

In some non-limiting embodiments, suitable internal glass sheets can be non-chemically-strengthened glass sheets such as soda-lime glass or can, in some embodiments, be chemically strengthened glass sheets. Optionally, the internal glass sheets can be heat strengthened. In embodiments where soda-lime glass is used as the non-chemically-strengthened glass sheet, conventional decorating materials and methods (e.g., glass frit enamels and screen printing) can be used, which can simplify the glass laminate manufacturing process. Tinted soda-lime glass sheets can be incorporated into a glass laminate structure to achieve desired transmission and/or attenuation across the electromagnetic spectrum.

Suitable external and/or internal glass sheets can be chemically strengthened by an ion exchange process. In this process discussed above, typically by immersion of the glass sheet into a molten salt bath for a predetermined period of time, ions at or near the surface of the glass sheet are exchanged for larger metal ions from the salt bath. In one embodiment, the temperature of the molten salt bath is about 430° C. and the predetermined time period is about eight hours. The incorporation of the larger ions into the glass strengthens the sheet by creating a compressive stress in a near surface region. A corresponding tensile stress is induced within a central region of the glass to balance the compressive stress. The chemically-strengthened as well as the non-chemically-strengthened glass, in some embodiments, can be batched with 0-2 mol. % of at least one fining agent selected from a group that includes Na₂SO₄, NaCl, NaF, NaBr, K₂SO₄, KCl, KF, KBr, and SnO₂.

According to various embodiments, glass laminate structures comprising ion-exchanged glass possess an array of desired properties, including low weight, high optical clarity, high impact resistance, and improved sound attenuation. In one embodiment, a chemically-strengthened glass sheet can have a surface compressive stress of at least 300 MPa, e.g., at least 400, 450, 500, 550, 600, 650, 700, 750 or 800 MPa, a depth of layer at least about 20 μm (e.g., at least about 20, 25, 30, 35, 40, 45, or 50 μm) and/or a central tension greater than 40 MPa (e.g., greater than 40, 45, or 50 MPa) but less than 100 MPa (e.g., less than 100, 95, 90, 85, 80, 75, 70, 65, 60, or 55 MPa). A modulus of elasticity of a chemically-strengthened glass sheet can range from about 60 GPa to 85 GPa (e.g., 60, 65, 70, 75, 80 or 85 GPa). The modulus of elasticity of the glass sheet(s) and the polymer interlayer can affect both the mechanical properties (e.g., deflection and strength) and the acoustic performance (e.g., transmission loss) of the resulting glass laminate.

Exemplary glass sheet forming methods include fusion draw and slot draw processes, which are each examples of a down-draw process, as well as float processes. These methods can be used to form both chemically-strengthened and non-chemically-strengthened glass sheets. The fusion draw process uses a drawing tank that has a channel for accepting molten glass raw material. The channel has weirs that are open at the top along the length of the channel on both sides of the channel. When the channel fills with molten material, the molten glass overflows the weirs. Due to gravity, the molten glass flows down the outside surfaces of the drawing tank. These outside surfaces extend down and inwardly so that they join at an edge below the drawing tank. The two flowing glass surfaces join at this edge to fuse and form a single flowing sheet. The fusion draw method offers the advantage that, because the two glass films flowing over the channel fuse together, neither outside surface of the resulting glass sheet comes in contact with any part of the apparatus. Thus, the surface properties of the fusion drawn glass sheet are not affected by such contact.

The slot draw method is distinct from the fusion draw method. Here the molten raw material glass is provided to a drawing tank. The bottom of the drawing tank has an open slot with a nozzle that extends the length of the slot. The molten glass flows through the slot/nozzle and is drawn downward as a continuous sheet and into an annealing region. The slot draw process can provide a thinner sheet than the fusion draw process because only a single sheet is drawn through the slot, rather than two sheets being fused together.

Down-draw processes produce glass sheets having a uniform thickness that possess surfaces that are relatively pristine. Because the strength of the glass surface is controlled by the amount and size of surface flaws, a pristine surface that has had minimal contact has a higher initial strength. When this high strength glass is then chemically strengthened, the resultant strength can be higher than that of a surface that has been a lapped and polished. Down-drawn glass may be drawn to a thickness of less than about 2 mm. In addition, down drawn glass has a very flat, smooth surface that can be used in its final application without costly grinding and polishing.

In the float glass method, a sheet of glass that may be characterized by smooth surfaces and uniform thickness is made by floating molten glass on a bed of molten metal, typically tin. In an exemplary process, molten glass that is fed onto the surface of the molten tin bed forms a floating ribbon. As the glass ribbon flows along the tin bath, the temperature is gradually decreased until a solid glass sheet can be lifted from the tin onto rollers. Once off the bath, the glass sheet can be cooled further and annealed to reduce internal stress.

Glass sheets can be used to form exemplary glass laminate structures (see, e.g., FIGS. 1 and 3-5). As defined herein, one non-limiting hybrid glass laminate structure comprises an externally-facing chemically-strengthened glass sheet, an internally-facing non-chemically-strengthened glass sheet, and a polymer interlayer formed between the glass sheets. Another non-limiting hybrid glass laminate structure comprises an externally-facing non-chemically-strengthened glass sheet, an internally-facing chemically-strengthened glass sheet, and a polymer interlayer formed between the glass sheets. Of course, another embodiment of the present disclosure can include a non-hybrid glass laminate structure which comprises externally-facing and internally-facing chemically-strengthened glass sheets with an intermediate polymer interlayer. Further embodiments can include externally-facing and/or internally-facing high UV transmission glass or high UV transmission, chemically-strengthened glass. Yet another embodiment of the present disclosure can include a glass laminate structure which comprises externally-facing and internally facing non-chemically-strengthened glass sheets with an intermediate polymer interlayer. The polymer interlayer in any of these structures can comprise a monolithic polymer sheet, a multilayer polymer sheet, or a composite polymer sheet. The polymer interlayer can be, for example, a plasticized poly(vinyl butyral) sheet having an additive to reduce discoloration.

Glass laminates can be adapted to provide an optically transparent barrier in architectural and automotive openings, e.g., automotive glazings. Glass laminates can be formed using a variety of processes. The assembly, in an exemplary embodiment, involves laying down a first sheet of glass, overlaying a polymer interlayer such as a PVB sheet, laying down a second sheet of glass, and then trimming the excess PVB to the edges of the glass sheets. Any one or both of these sheets of glass can be high UV transmission glass. A tacking step can include expelling most of the air from the interfaces and partially bonding the PVB to the glass sheets. The finishing step, typically carried out at elevated temperature and pressure, completes the mating of each of the glass sheets to the polymer interlayer. In the foregoing embodiment, the first sheet can be a chemically-strengthened glass sheet, a high UV transmission glass sheet, or a high UV transmission, chemically-strengthened glass sheet and the second sheet can be a non-chemically-strengthened glass sheet or vice versa.

A thermoplastic material such as PVB may be applied as a preformed polymer interlayer. The thermoplastic layer can, in certain embodiments, have a thickness of at least 0.125 mm (e.g., 0.125, 0.25, 0.38, 0.5, 0.7, 0.76, 0.81, 1, 1.14, 1.19 or 1.2 mm). The thermoplastic layer can have a thickness of less than or equal to 1.6 mm (e.g., from 0.4 to 1.2 mm, such as about 0.4, 0.5, 0.6, 0.7, 0.8, 0.9, 1.0, 1.1 or 1.2 mm). Of course, the claims appended herewith should not be so limited as the thermoplastic layer can have thicknesses greater than 1.6 mm (e.g., from 1.6 mm to 3.0 mm, from 2.0 mm to 2.54 mm, etc.). The thermoplastic layer can cover most or, preferably, substantially all of the two opposed major faces of the glass. It may also cover the edge faces of the glass. The glass sheets in contact with the thermoplastic layer may be heated above the softening point of the thermoplastic, such as, for example, at least 5° C. or 10° C. above the softening point, to promote bonding of the thermoplastic material to the respective glass sheets. The heating can be performed with the glass in contact with the thermoplastic layers under pressure. One or more polymer interlayers may be incorporated into an exemplary glass laminate structure. A plurality of interlayers may provide complimentary or distinct functionality, including impact performance, adhesion promotion, acoustic control, UV transmission control, tinting, coloration and/or IR transmission control.

A modulus of elasticity of the polymer interlayer can range from about 1 MPa to 320 MPa (e.g., about 1, 2, 5, 10, 15, 20, 25, 50, 75, 100, 150, 200, 250, 300 or 320 MPa) at about 25° C. At a loading rate of 1 Hz, a modulus of elasticity of a standard PVB interlayer can be about 15 MPa, and a modulus of elasticity of an acoustic grade PVB interlayer can be about 2 MPa.

During the lamination process, the interlayer can be typically heated to a temperature effective to soften the interlayer, which promotes a conformal mating of the interlayer to respective surfaces of the glass sheets. For PVB, a lamination temperature can be about 140° C. Mobile polymer chains within the interlayer material develop bonds with the glass surfaces, which promote adhesion. Elevated temperatures also accelerate the diffusion of residual air and/or moisture from the glass-polymer interface. The application of pressure both promotes flow of the interlayer material, and suppresses bubble formation that otherwise could be induced by the combined vapor pressure of water and air trapped at the interfaces. To suppress bubble formation, heat and pressure are simultaneously applied to the assembly in an autoclave.

It has been determined that glass laminate structures having polymeric interlayers can discolor due to environmental conditions, e.g., UV exposure and the like. In laminate structures having high UV transmission glass layers or sheets, e.g., chemically-strengthened glass sheets such as Gorilla® Glass or other high UV transmission glass, exemplary polymer interlayers such as PVB can discolor or yellow after extended exposure to a UV light source. Laminate structures having low UV transmission glass layers or sheets (e.g., a standard soda lime glass having high-iron content, or the like) and a PVB interlayer also discolor but at a slower rate as illustrated in Table 1 below where a discoloration or change in yellowing index (ΔYI) was used as a measure of the discoloration or yellowing of the glass laminate structure.

TABLE 1

| | Change in Yellowing Index (ΔYI) of | |
|---|---|---|
| | Laminate after UV Exposure | |
| Glass type used in laminate | Dose = 494 MJ/m² | Dose = 1093 MJ/m² |
| structure | (295~385 nm) | (295~385 nm) |
| Standard soda lime glass | 0.19 | 0.54 |
| Chemically strengthened glass | 0.83 | 1.03 |

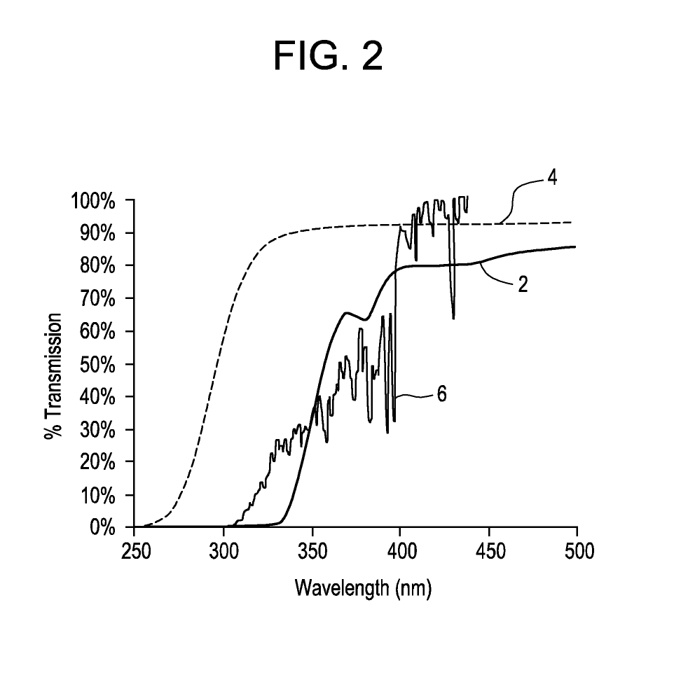

Further experimentation identified that the UV transmission (i.e., greater optical clarity) of exemplary glass sheets (e.g., in one embodiment, Gorilla® Glass, Starphire® Glass) can be much higher than that of standard soda lime glass as illustrated in FIG. 2. FIG. 2 is a plot comparing UV transmission of standard soda lime glass 2 with a high UV transmission, chemically-strengthened glass embodiment (e.g., Gorilla® Glass) 4. UV transmission of the solar spectrum 6 is provided for ease of reference. As illustrated, the higher UV transmission 4 associated with the chemically strengthened glass can result in more UV light reaching a PVB interlayer which causes the PVB to yellow at a faster rate than it would in less optically clear laminate structures having standard soda lime glass 2. Such a problem can be expected to occur with glass compositions having high UV transmission thus, other such high UV transmission glass materials (e.g., low-iron soda lime glass such as Starphire® Glass) can exhibit similar discoloring issues.

Several weathering tests of exemplary laminate structures were performed. In one experiment, laminate structures having chemically-strengthened glass exhibited some discoloration or yellowing after 2000 hours of exposure in a weatherometer, and laminate structures having the same PVB interlayer but with soda lime glass still yellowed but at a slower rate after the same amount of exposure. Deconstruction of these laminate structures noted that the glass sheets did not discolor but rather, the polymer interlayer yellowed. Such a discoloration can provide a product having a color different from that specified by a customer and, in some cases if multiple laminate structures are adjacent to each other and a weathered structure must be replaced, the new laminate structure will have a mismatched color in comparison to adjacent weathered laminate structures.

In some embodiments of the present disclosure, it was determined that by providing an additive to exemplary polymer interlayers, this discoloration could be reduced and/or eliminated. In one embodiment, a phenol, 2-(2H-benzotriazol-2-yl)-4,6-bis(1,1-dimethylpropyl) additive can be employed with a polymer interlayer. The molecular structure of phenol, 2-(2H-benzotriazol-2-yl)-4,6-bis(1,1-dimethylpropyl) is provided below.

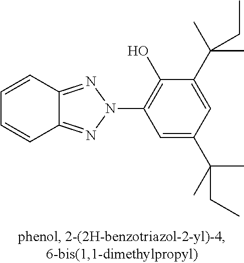 [SMILES: CCC(C)(C)c1cc(-n2nc3ccccc3n2)c(O)c(C(C)(C)CC)c1]

Thus, exemplary embodiments of the present disclosure can include the additive phenol, 2-(2H-benzotriazol-2-yl)-4,6-bis(1,1-dimethylpropyl) in a polymer interlayer to reduce or eliminate discoloration of the interlayer material due to UV exposure. In some embodiments, phenol, 2-(2H-benzotriazole-2-yl)-4,6-bis(1,1-dimethylpropyl) can be used in combination with one or more suitable stabilizers such as, but not limited to, hindered amine light stabilizers, antioxidants, hindered phenols, and the like.

In another embodiment, a phenol, 2-(5-chloro-2H-benzotriazol-2-yl)-6-(1,1-dimethylethyl)-4-methyl additive can be employed with a polymer interlayer. The molecular structure of phenol, 2-(5-chloro-2H-benzotriazol-2-yl)-6-(1,1-dimethylethyl)-4-methyl is provided below.

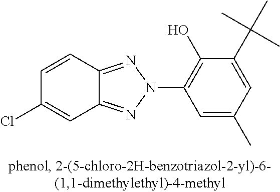 [SMILES: Cc1cc(-n2nc3ccc(Cl)cc3n2)c(O)c(C(C)(C)C)c1]

Other embodiments of the present disclosure can include the additive phenol, 2-(5-chloro-2H-benzotriazol-2-yl)-6-(1,1-dimethylethyl)-4-methyl in a polymer interlayer. Additional embodiments of the present disclosure can include the additive 2-(2H-benzotriazole-2-yl)-4,6-ditertpentyl phenol or similar additives. In other embodiments, any of the aforementioned additives can be used in combination with one or more stabilizers such as, but not limited to, hindered amine light stabilizers, antioxidants, hindered phenols, and the like.

In further embodiments, UV absorbers of the hydroxyphenyl benzotriazole class can be employed with a polymer interlayer. By way of a non-limiting example, a 2-(2H-benzotriazol-2-yl)-4,6-bis(1-methyl-1-phenylethyl)phenol additive can be employed with a polymer interlayer. The molecular structure of 2-(2H-benzotriazol-2-yl)-4,6-bis(1-methyl-1-phenylethyl)phenol is provided below.

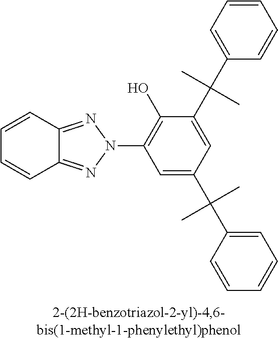 [SMILES: CC(C)(c1ccccc1)c1cc(-n2nc3ccccc3n2)c(O)c(C(C)(C)c2ccccc2)c1]

In yet a further non-limiting example, a 2-(2H-Benzotriazol-2-yl)-6-(1-methyl-1-phenylethyl)-4-(1,1,3,3-tetramethylbutyl)phenol additive can be employed with a polymer interlayer. The molecular structure of 2-(2H-Benzotriazol-2-yl)-6-(1-methyl-1-phenylethyl)-4-(1,1,3,3-tetramethylbutyl)phenol is provided below.

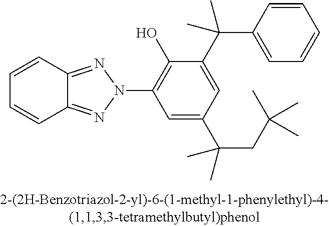 [SMILES: CC(C)(C)CC(C)(C)c1cc(-n2nc3ccccc3n2)c(O)c(C(C)(C)c2ccccc2)c1]

Of course, these UV absorber from the hydroxyphenyl benzotriazole class are exemplary only and should not limit the scope of the claims appended herewith. In other embodiments, any of the aforementioned additives can be used in combination with one or more stabilizers such as, but not limited to, hindered amine light stabilizers, antioxidants, hindered phenols, and the like. In additional non-limiting embodiments, exemplary additives can include hydroxyphenyl substituted benzotriazoles without a chlorine substituent.

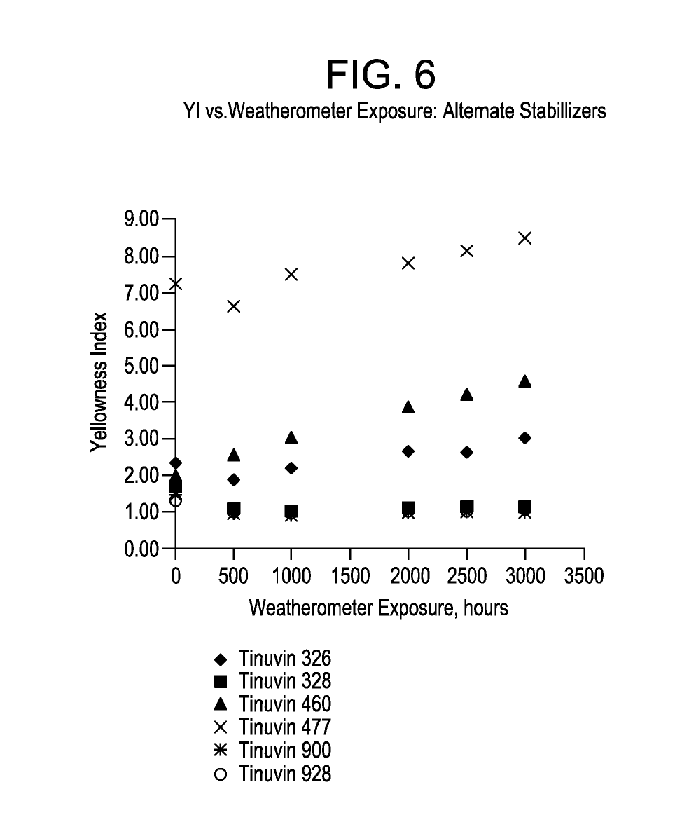

FIG. 6 is a plot comparing transmissions of yellowness index versus exposure of other embodiments of the present disclosure. With reference to FIG. 6, it can be observed that each of a phenol, 2-(2H-benzotriazol-2-yl)-4,6-bis(1,1-dimethylpropyl) additive (e.g., Tinuvin 328), a 2-(2H-benzotriazol-2-yl)-4,6-bis(1-methyl-1-phenylethyl)phenol additive (e.g., Tinuvin 900), and a 2-(2H-Benzotriazol-2-yl)-6-(1-methyl-1-phenylethyl)-4-(1,1,3,3-tetramethylbutyl)phenol additive (e.g., Tinuvin 928) provide similar, and comparatively low, yellowing when compared to other stabilizers that include benzotriazoles with a chlorine substituent, triazines, benzophenones, etc. (Tunuvin 326, Tinuvin 460, Tinuvin 477) at comparable exposures up to 3000 hours.

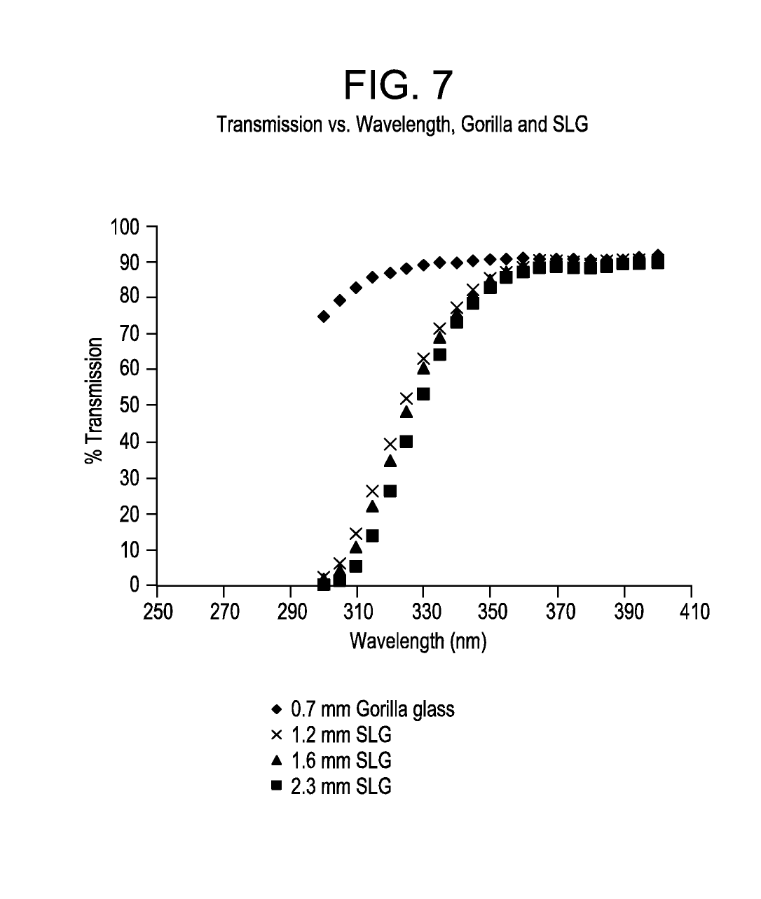

It should be noted that while reference has been made to chemically strengthened glass substrates, e.g., Gorilla Glass, the claims appended herewith should not be so limited as exemplary embodiments can include any type of glass having a high transmission value (as a function of thickness, composition, etc.). For example, FIG. 7 is a plot comparing transmission values of some embodiments of the present disclosure. As observed in FIG. 7, transmission values of 0.7 mm Gorilla glass and 1.2 mm, 1.6 mm and 2.3 mm thick soda lime glass each increase as a function of transmission spectrum.

Glass laminate structures as described herein can thus provide beneficial effects, including the attenuation of acoustic noise, reduction of UV and/or IR light transmission, prevention of discoloration, and/or enhancement of the aesthetic appeal of a window opening. The individual glass sheets used in the disclosed glass laminate structures (as well as the formed laminate structures) can be characterized by one or more attributes, including composition, density, thickness, surface metrology, as well as various properties including optical, sound-attenuation, and mechanical properties such as impact resistance. Various aspects of the disclosed glass laminate structures, hybrid or otherwise, are described herein.

Exemplary glass laminate structures can be adapted for use, for example, as windows or glazings, and configured to any suitable size and dimension. In embodiments, the glass laminate structures have a length and width that independently vary from 10 cm to 1 m or more (e.g., 0.1, 0.2, 0.5, 1, 2, or 5 m). Independently, the glass laminate structures can have an area of greater than 0.1 m², e.g., greater than 0.1, 0.2, 0.5, 1, 2, 5, 10, or 25 m².

The glass laminate structures can be substantially flat or shaped for certain applications. For instance, the glass laminate structures can be formed as bent or shaped parts for use as windshields or other windows. The structure of a shaped glass laminate structure may be simple or complex. In certain embodiments, a shaped glass laminate structure may have a complex curvature where the glass sheets have a distinct radius of curvature in two independent directions. Such shaped glass sheets may thus be characterized as having “cross curvature,” where the glass is curved along an axis that is parallel to a given dimension and also curved along an axis that is perpendicular to the same dimension. An automobile sunroof, for example, typically measures about 0.5 m by 1.0 m and has a radius of curvature of 2 to 2.5 m along the minor axis, and a radius of curvature of 4 to 5 m along the major axis.

Shaped glass laminate structures according to certain embodiments can be defined by a bend factor, where the bend factor for a given part is equal to the radius of curvature along a given axis divided by the length of that axis. Thus, for the exemplary automotive sunroof having radii of curvature of 2 m and 4 m along respective axes of 0.5 m and 1.0 m, the bend factor along each axis is 4. Shaped glass laminates can have a bend factor ranging from 2 to 8 (e.g., 2, 3, 4, 5, 6, 7, or 8).

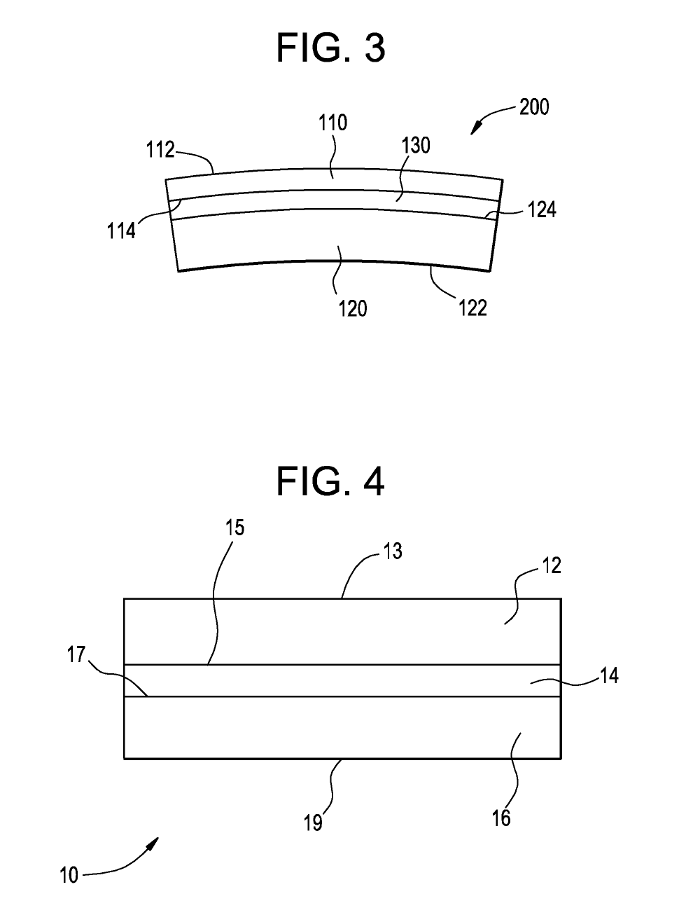

An exemplary shaped glass laminate structure 200 is illustrated in FIG. 3. The shaped laminate structure 200 comprises an external high UV transmission (e.g., chemically-strengthened) glass sheet 110 formed at a convex surface of the laminate while an internal (non-chemically-strengthened) glass sheet 120 is formed on a concave surface of the laminate. It will be appreciated, however, that the convex surface of a non-illustrated embodiment can comprise a non-chemically-strengthened glass sheet while an opposing concave surface can comprise a chemically-strengthened glass sheet. Of course, the convex and concave surfaces can both comprise chemically-strengthened glass sheets or non-chemically-strengthened glass sheets.

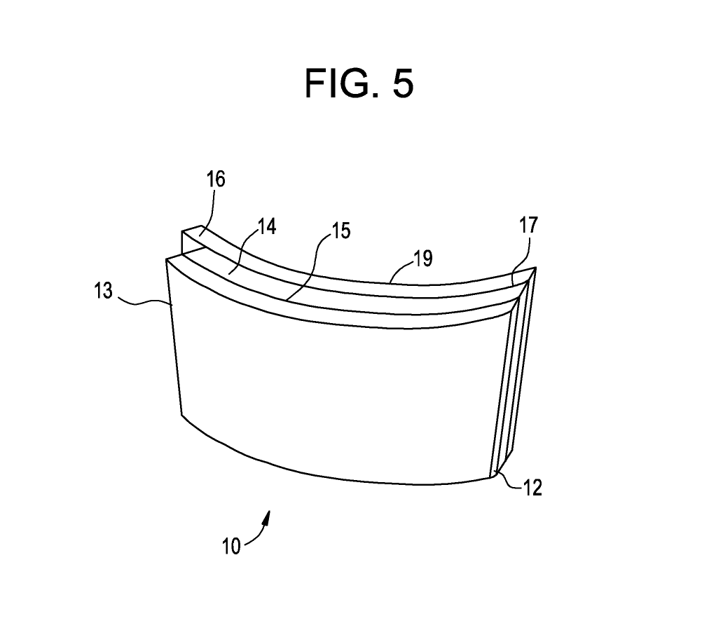

FIG. 4 is a cross sectional illustration of further embodiments of the present disclosure. FIG. 5 is a perspective view of additional embodiments of the present disclosure. With reference to FIGS. 4 and 5 and as discussed in previous paragraphs, an exemplary laminate structure 10 can include an inner layer 16 of chemically strengthened glass, e.g., Gorilla® Glass. This inner layer 16 can be heat treated, ion exchanged and/or annealed. The outer layer 12 can be a high UV transmission glass sheet (e.g., a non-chemically strengthened glass sheet) such as a low iron soda lime glass, annealed glass, or the like. The laminate 10 can also include a polymeric interlayer 14 intermediate the outer and inner glass layers. Of course, in additional embodiments, the inner layer 16 can be comprised of non-chemically strengthened glass and the outer layer 12 can be comprised of chemically strengthened glass. In a further embodiment, both the outer and inner layers 12, 16 can be comprised of chemically-strengthened glass or both the outer and inner layers 12, 16 can be comprised of non-chemically-strengthened glass. The inner layer of glass 16 can have a thickness of less than or equal to 1.0 mm and can have a residual surface CS level of between about 250 MPa to about 350 MPa with a DOL of greater than 60 microns. In another embodiment the CS level of the inner layer 16 can be about 300 MPa. In one embodiment, an interlayer 14 can have a thickness of approximately 0.8 mm. Exemplary interlayers 14 can include, but are not limited to, polyvinylbutyral or other suitable polymeric materials as described herein. In a preferred embodiment, a phenol, 2-(2H-benzotriazol-2-yl)-4,6-bis(1,1-dimethylpropyl) additive can be employed with the polymer interlayer 14 to prevent or eliminate discoloration thereof when the glass laminate structure is exposed to a UV environment. In other embodiments, the phenol, 2-(2H-benzotriazole-2-yl)-4,6-bis(1,1-dimethylpropyl) can be used in combination with one or more suitable stabilizers such as, but not limited to, hindered amine light stabilizers, antioxidants, hindered phenols, and the like. In additional embodiments, any of the surfaces of the outer and/or inner layers 12, 16 can be acid etched to improve durability to external impact events. For example, in one embodiment, a first surface 13 of the outer layer 12 can be acid etched and/or another surface 17 of the inner layer can be acid etched. In another embodiment, a first surface 15 of the outer layer can be acid etched and/or another surface 19 of the inner layer can be acid etched. Such embodiments can thus provide a laminate construction substantially lighter than conventional laminate structures with high optical clarity and which conforms to regulatory impact requirements. Exemplary thicknesses of the outer and/or inner layers 12, 16 can range in thicknesses from 0.5 mm to 1.5 mm to 2.0 mm to 3.0 mm or more.

In some embodiments of the present disclosure a glass laminate structure is provided having a non-chemically strengthened external glass sheet, a chemically strengthened internal glass sheet, and at least one polymer interlayer intermediate the external and internal glass sheets. The polymer interlayer can include a phenol, 2-(2H-benzotriazol-2-yl)-4,6-bis(1,1-dimethylpropyl) additive. In other embodiments, the internal glass sheet can have a thickness ranging from about 0.5 mm to about 1.5 mm, and the external glass sheet can have a thickness ranging from about 1.5 mm to about 3.0 mm. The internal glass sheet can include one or more alkaline earth oxides, such that a content of alkaline earth oxides is at least about 5 wt. %. In other embodiments, the internal glass sheet can include at least about 6 wt. % aluminum oxide. In some embodiments, the internal glass sheet can have a thickness of between about 0.5 mm to about 0.7 mm. Exemplary polymer interlayers can comprise a single polymer sheet, a multilayer polymer sheet, or a composite polymer sheet. Exemplary materials for the polymer interlayer can be, but are not limited to, poly vinyl butyral (PVB), polycarbonate, acoustic PVB, ethylene vinyl acetate (EVA), thermoplastic polyurethane (TPU), ionomer, PET, a thermoplastic material, and combinations thereof. The polymer interlayer can have a thickness of between about 0.4 to about 1.2 mm to about 2.5 mm to about 3.0 mm. In some embodiments, the external glass sheet can comprise a material selected from the group consisting of soda-lime glass and annealed glass. In other embodiments, the external glass sheet can have a thickness of about 2.1 mm. In additional embodiments, the glass laminate can have an area greater than 1 m² and can be, for example, an automotive windshield, sunroof or other automotive window (side, rear, etc.). In some embodiments, the internal glass sheet can have a surface compressive stress between about 250 MPa and about 900 MPa. In other embodiments, the internal glass sheet can have a surface compressive stress of between about 250 MPa and about 350 MPa and a DOL of compressive stress greater than about 20 μm. In further embodiments, a surface of the external glass sheet adjacent the interlayer can be acid etched and/or a surface of the internal glass sheet opposite the interlayer can be acid etched.

In other embodiments of the present disclosure a glass laminate structure is provided having a non-chemically strengthened internal glass sheet, a chemically strengthened external glass sheet, and at least one polymer interlayer intermediate the external and internal glass sheets. The polymer interlayer can include a phenol, 2-(2H-benzotriazol-2-yl)-4,6-bis(1,1-dimethylpropyl) additive. In other embodiments, the external glass sheet can have a thickness ranging from about 0.5 mm to about 1.5 mm, and the internal glass sheet can have a thickness ranging from about 1.5 mm to about 3.0 mm. In some embodiments, the external glass sheet can include one or more alkaline earth oxides, such that a content of alkaline earth oxides is at least about 5 wt. %. In additional embodiments, the external glass sheet can include at least about 6 wt. % aluminum oxide. In further embodiments, the external glass sheet can have a thickness of between about 0.5 mm to about 0.7 mm. Exemplary polymer interlayers can comprise a single polymer sheet, a multilayer polymer sheet, or a composite polymer sheet. Exemplary materials for the polymer interlayer can be, but are not limited to, poly vinyl butyral (PVB), polycarbonate, acoustic PVB, ethylene vinyl acetate (EVA), PET, thermoplastic polyurethane (TPU), ionomer, a thermoplastic material, and combinations thereof. In some embodiments, the polymer interlayer can have a thickness of between about 0.4 to about 1.2 mm to about 2.5 mm to about 3.0 mm. Exemplary materials for the internal glass sheet can comprise a material such as, but not limited to, soda-lime glass and annealed glass. In some embodiments, the internal glass sheet can have a thickness of about 2.1 mm. In other embodiments, the glass laminate can have an area greater than 1 m² and can also be an automotive windshield, sunroof or other automotive window (side, rear, etc.). In additional embodiments, the external glass sheet can have a surface compressive stress between about 250 MPa and about 900 MPa, and the external glass sheet can have a surface compressive stress of between about 250 MPa and about 350 MPa and a DOL of compressive stress greater than about 20 μm. In further embodiments, a surface of the internal glass sheet adjacent the interlayer can be acid etched, and a surface of the external glass sheet opposite the interlayer can be acid etched.

In further embodiments of the present disclosure a glass laminate structure is provided having an internal glass sheet, an external glass sheet, and at least one polymer interlayer intermediate the external and internal glass sheets. The polymer interlayer can include a phenol, 2-(2H-benzotriazol-2-yl)-4,6-bis(1,1-dimethylpropyl) additive. In some embodiments, the internal glass sheet can be formed from chemically-strengthened glass and the external glass sheet can be formed from non-chemically strengthened glass. In other embodiments, the external glass sheet can be formed from chemically-strengthened glass and the internal glass sheet can be formed from non-chemically strengthened glass. In further embodiments, both the internal and external glass sheets can be formed from chemically-strengthened glass. In yet additional embodiments, both the internal and external glass sheets can be formed from non-chemically-strengthened glass. Exemplary polymer interlayers can comprise a single polymer sheet, a multilayer polymer sheet, or a composite polymer sheet. Exemplary materials for the polymer interlayer can be, but are not limited to, poly vinyl butyral (PVB), polycarbonate, acoustic PVB, ethylene vinyl acetate (EVA), thermoplastic polyurethane (TPU), PET, ionomer, a thermoplastic material, and combinations thereof. In some embodiments, the polymer interlayer can have a thickness of between about 0.4 to about 1.2 mm to about 2.5 mm to about 3.0 mm. In other embodiments, the glass laminate can have an area greater than 1 m² and can also be an automotive windshield, sunroof or other automotive window (side, rear, etc.). In additional embodiments, one or more surfaces of the internal and external glass sheets can be acid etched.

Embodiments of the present disclosure may thus offer a means to reduce the weight of automotive glazing by using thinner glass materials while maintaining optical and safety requirements. Conventional laminated windshields may account for 62% of a vehicle's total glazing weight; however, by employing a 0.7-mm thick chemically strengthened inner layer with a 2.1-mm thick non-chemically strengthened outer layer, for example, windshield weight can be reduced by 33%. Furthermore, it has been discovered that use of a 1.6-mm thick non-chemically strengthened outer layer with the 0.7-mm thick chemically strengthened inner layer results in an overall 45% weight savings. Thus, use of exemplary laminate structures according to embodiments of the present disclosure may allow a laminated windshield to pass all regulatory safety requirements including resistance to penetration from internal and external objects and appropriate flexure resulting in acceptable Head Impact Criteria (HIC) values. In addition, an exemplary external layer comprised of annealed glass may offer acceptable break patterns caused by external object impacts and allow for continued operational visibility through the windshield when a chip or crack occurs as a result of the impact. Research has also demonstrated that employing chemically strengthened glass as an interior surface of an asymmetrical windshield provides an added benefit of reduced laceration potential compared to that caused by occupant impact with conventional annealed windshields. In embodiments of the present disclosure utilized in automobiles or other devices or structures subject to an external environment, exemplary laminate structures can employ high UV transmission glass compositions without discoloration of the polymer interlayer.

Methods for bending and/or shaping glass laminates can include gravity bending, press bending and methods that are hybrids thereof. In a traditional method of gravity bending thin, flat sheets of glass into curved shapes such as automobile windshields, cold, pre-cut single or multiple glass sheets are placed onto the rigid, pre-shaped, peripheral support surface of a bending fixture. The bending fixture may be made using a metal or a refractory material. In an exemplary method, an articulating bending fixture may be used. Prior to bending, the glass typically is supported only at a few contact points. The glass is heated, usually by exposure to elevated temperatures in a lehr, which softens the glass allowing gravity to sag or slump the glass into conformance with the peripheral support surface. Substantially the entire support surface generally will then be in contact with the periphery of the glass.

A related technique is press bending where a single flat glass sheet is heated to a temperature corresponding substantially to the softening point of the glass. The heated sheet is then pressed or shaped to a desired curvature between male and female mold members having complementary shaping surfaces. The mold member shaping surfaces may include vacuum or air jets for engaging with the glass sheets. In embodiments, the shaping surfaces may be configured to contact substantially the entire corresponding glass surface. Alternatively, one or both of the opposing shaping surfaces may contact the respective glass surface over a discrete area or at discrete contact points. For example, a female mold surface may be ring-shaped surface. In embodiments, a combination of gravity bending and press bending techniques can be used.

A total thickness of the glass laminate can range from about 2 mm to 7 mm to about 10 mm to about 20 mm, with the external and/or internal chemically-strengthened glass sheets having a thickness of 1 mm or less (e.g., from 0.3 to 1 mm such as, for example, 0.3, 0.4, 0.5, 0.6, 0.7, 0.8, 0.9 or 1 mm). Further, the internal and/or external non-chemically-strengthened glass sheets can have a thickness of 12 mm to 2.5 mm or less (e.g., from 1 to 2.5 mm such as, for example, 1, 1.5, 2 or 2.5 mm) or may have a thickness of 2.5 mm or more. In embodiments, the total thickness of the glass sheets in the glass laminate is less than 3.5 mm (e.g., less than 3.5, 3, 2.5 or 2.3 mm).

The glass laminate structures disclosed herein can also have excellent durability, impact resistance, toughness, optical clarity and scratch resistance. As is well known among skilled artisans, the strength and mechanical impact performance of a glass sheet or laminate is limited by defects in the glass, including both surface and internal defects. When a glass laminate is impacted, the impact point is put into compression, while a ring or “hoop” around the impact point, as well as the opposite face of the impacted sheet, are put into tension. Typically, the origin of failure will be at a flaw, usually on the glass surface, at or near the point of highest tension. This can occur on the opposite face, but can occur within the ring. If a flaw in the glass is put into tension during an impact event, the flaw will likely propagate, and the glass will typically break. Thus, a high magnitude and depth of compressive stress (depth of layer) can be preferable in embodiments having chemically strengthened glass.

Due to chemical strengthening, one or both of the surfaces of the chemically-strengthened glass sheets used in some hybrid glass laminates are under compression. The incorporation of a compressive stress in a near surface region of the glass can inhibit crack propagation and failure of the glass sheet. In order for flaws to propagate and failure to occur, the tensile stress from an impact must exceed the surface compressive stress at the tip of the flaw. In some embodiments, the high compressive stress and high depth of layer of chemically-strengthened glass sheets enable the use of thinner glass than in the case of non-chemically-strengthened glass.

In the case of hybrid glass laminates, the laminate structure can deflect without breaking in response to the mechanical impact much further than thicker monolithic, non-chemically-strengthened glass or thicker, non-chemically-strengthened glass laminates. This added deflection enables more energy transfer to the laminate interlayer, which can reduce the energy that reaches the opposite side of the glass. Consequently, the hybrid glass laminates disclosed herein can withstand higher impact energies than monolithic, non-chemically-strengthened glass or non-chemically-strengthened glass laminates of similar thickness.

In addition to their mechanical properties, as will be appreciated by a skilled artisan, laminated structures can be used to dampen acoustic waves. The hybrid glass laminates disclosed herein can dramatically reduce acoustic transmission while using thinner (and lighter) structures that also possess the requisite mechanical properties for many glazing applications.

The acoustic performance of laminates and glazings is commonly impacted by the flexural vibrations of the glazing structure. Without wishing to be bound by theory, human acoustic response peaks typically between 500 Hz and 5000 Hz, corresponding to wavelengths of about 0.1-1 m in air and 1-10 m in glass. For a glazing structure less than 0.01 m (<10 mm) thick, transmission occurs mainly through coupling of vibrations and acoustic waves to the flexural vibration of the glazing. Laminated glazing structures can be designed to convert energy from the glazing flexural modes into shear strains within the polymer interlayer. In glass laminates employing thinner glass sheets, the greater compliance of the thinner glass permits a greater vibrational amplitude, which in turn can impart greater shear strain on the interlayer. The low shear resistance of most viscoelastic polymer interlayer materials means that the interlayer will promote damping via the high shear strain that will be converted into heat under the influence of molecular chain sliding and relaxation.

In addition to the glass laminate thickness, the nature of the glass sheets that comprise the laminates may also influence the sound attenuating properties. For instance, as between chemically-strengthened and non-chemically-strengthened glass sheets, there may be small but significant difference at the glass-polymer interlayer interface that contributes to higher shear strain in the polymer layer. Also, in addition to their obvious compositional differences, aluminosilicate glasses and soda lime glasses have different physical and mechanical properties, including modulus, Poisson's ratio, density, etc., which may result in a different acoustic response.

While this description may include many specifics, these should not be construed as limitations on the scope thereof, but rather as descriptions of features that may be specific to particular embodiments. Certain features that have been heretofore described in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and may even be initially claimed as such, one or more features from a claimed combination may in some cases be excised from the combination, and the claimed combination may be directed to a subcombination or variation of a subcombination.

Similarly, while operations are depicted in the drawings or figures in a particular order, this should not be understood as requiring that such operations be performed in the particular order shown or in sequential order, or that all illustrated operations be performed, to achieve desirable results. In certain circumstances, multitasking and parallel processing may be advantageous.

Ranges can be expressed herein as from “about” one particular value, and/or to “about” another particular value. When such a range is expressed, examples include from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

It is also noted that recitations herein refer to a component of the present disclosure being “configured” or “adapted to” function in a particular way. In this respect, such a component is “configured” or “adapted to” embody a particular property, or function in a particular manner, where such recitations are structural recitations as opposed to recitations of intended use. More specifically, the references herein to the manner in which a component is “configured” or “adapted to” denotes an existing physical condition of the component and, as such, is to be taken as a definite recitation of the structural characteristics of the component.

As shown by the various configurations and embodiments illustrated in the figures, various non-yellowing glass laminate structures have been described.

While preferred embodiments of the present disclosure have been described, it is to be understood that the embodiments described are illustrative only and that the scope of the invention is to be defined solely by the appended claims when accorded a full range of equivalence, many variations and modifications naturally occurring to those of skill in the art from a perusal hereof.

What is claimed is:

1. A glass laminate structure comprising:
a non-chemically strengthened external glass sheet;
a high UV transmission internal glass sheet; and
at least one polymer interlayer intermediate the external and internal glass sheets,
wherein the polymer interlayer includes a phenol, 2-(2H-benzotriazol-2-yl)-4,6-bis(1,1-dimethylpropyl), a 2-(2H-benzotriazol-2-yl)-4,6-bis(1-methyl-1-phenylethyl)phenol additive, a 2-(2H-Benzotriazol-2-yl)-6-(1-methyl-1-phenylethyl)-4-(1,1,3,3-tetramethylbutyl)phenol additive, or an hydroxyphenyl substituted benzotriazole additive without a chlorine substituent.

2. The glass laminate structure of claim 1, wherein the internal glass sheet is a chemically strengthened glass sheet and has a thickness ranging from about 0.3 mm to about 1.5 mm, and
wherein the external glass sheet has a thickness ranging from about 1.0 mm to about 12.0 mm.

3. The glass laminate structure of claim 1, wherein the internal glass sheet has a thickness of between about 0.3 mm to about 0.7 mm.

4. The glass laminate structure of claim 1, wherein the polymer interlayer comprises a single polymer sheet, a multilayer polymer sheet, or a composite polymer sheet.

5. The glass laminate structure of claim 1, wherein the polymer interlayer comprises a material selected from the group consisting of poly vinyl butyral (PVB), polycarbonate, acoustic PVB, PET, ethylene vinyl acetate (EVA), thermoplastic polyurethane (TPU), ionomer, a thermoplastic material, and combinations thereof.

6. The glass laminate structure of claim 1, wherein the polymer interlayer has a thickness of between about 0.4 to about 1.2 mm to about 2.5 mm.

7. The glass laminate structure of claim 1, wherein the external glass sheet comprises a material selected from the group consisting of soda-lime glass and annealed glass.

8. The glass laminate structure of claim 1, wherein the glass laminate is an automotive window.

9. The glass laminate structure of claim 1, wherein the internal glass sheet has a surface compressive stress between about 250 MPa and about 900 MPa.

10. The glass laminate structure of claim 1, wherein the internal glass sheet has a surface compressive stress of between about 250 MPa and about 350 MPa and a DOL of compressive stress greater than about 20 μm.

11. A glass laminate structure comprising:
a non-chemically strengthened internal glass sheet;
a high UV transmission external glass sheet; and
at least one polymer interlayer intermediate the external and internal glass sheets,
wherein the polymer interlayer includes a phenol, 2-(2H-benzotriazol-2-yl)-4,6-bis(1,1-dimethylpropyl) additive, a 2-(2H-benzotriazol-2-yl)-4,6-bis(1-methyl-1-phenylethyl)phenol additive, a 2-(2H-Benzotriazol-2-yl)-6-(1-methyl-1-phenylethyl)-4-(1,1,3,3-tetramethylbutyl)phenol additive, or an hydroxyphenyl substituted benzotriazole additive without a chlorine substituent.

12. The glass laminate structure of claim 11, wherein the external glass sheet is chemically strengthened and has a thickness ranging from about 0.3 mm to about 1.5 mm, and
wherein the internal glass sheet has a thickness ranging from about 1.0 mm to about 12.0 mm.

13. The glass laminate structure of claim 11, wherein the external glass sheet has a thickness of between about 0.3 mm to about 0.7 mm.

14. The glass laminate structure of claim 11, wherein the polymer interlayer comprises a single polymer sheet, a multilayer polymer sheet, or a composite polymer sheet.

15. The glass laminate structure of claim 11, wherein the polymer interlayer comprises a material selected from the group consisting of poly vinyl butyral (PVB), polycarbonate, acoustic PVB, ethylene vinyl acetate (EVA), thermoplastic polyurethane (TPU), ionomer, a thermoplastic material, and combinations thereof.

16. The glass laminate structure of claim 11, wherein the polymer interlayer has a thickness of between about 0.4 to about 1.2 mm to about 2.5 mm.

17. The glass laminate structure of claim 11, wherein the internal glass sheet comprises a material selected from the group consisting of soda-lime glass and annealed glass.

18. The glass laminate structure of claim 11, wherein the glass laminate is an automotive window.

19. The glass laminate structure of claim 11, wherein the external glass sheet has a surface compressive stress between about 250 MPa and about 900 MPa.

20. The glass laminate structure of claim 11, wherein the external glass sheet has a surface compressive stress of between about 250 MPa and about 350 MPa and a DOL of compressive stress greater than about 20 μm.

21. A glass laminate structure comprising:
an internal glass sheet;
an external glass sheet; and
at least one polymer interlayer intermediate the external and internal glass sheets,
wherein the polymer interlayer includes a phenol, 2-(2H-benzotriazol-2-yl)-4,6-bis(1,1-dimethylpropyl) additive, a 2-(2H-benzotriazol-2-yl)-4,6-bis(1-methyl-1-phenylethyl)phenol additive, a 2-(2H-Benzotriazol-2-yl)-6-(1-methyl-1-phenylethyl)-4-(1,1,3,3-tetramethylbutyl)phenol additive, or an hydroxyphenyl substituted benzotriazole additive without a chlorine substituent.

22. The glass laminate structure of claim 21 wherein the internal glass sheet is formed from chemically-strengthened glass and the external glass sheet is formed from non-chemically strengthened glass.

23. The glass laminate structure of claim 21 wherein the external glass sheet is formed from chemically-strengthened glass and the internal glass sheet is formed from non-chemically strengthened glass.

24. The glass laminate structure of claim 21 wherein both the internal and external glass sheets are formed from chemically-strengthened glass or from non-chemically-strengthened glass.

25. The glass laminate structure of claim 21, wherein the polymer interlayer comprises a single polymer sheet, a multilayer polymer sheet, or a composite polymer sheet.

26. The glass laminate structure of claim 21, wherein the polymer interlayer comprises a material selected from the group consisting of poly vinyl butyral (PVB), polycarbonate, acoustic PVB, PET, ethylene vinyl acetate (EVA), thermoplastic polyurethane (TPU), ionomer, a thermoplastic material, and combinations thereof.

27. The glass laminate structure of claim 21, wherein the polymer interlayer has a thickness of between about 0.4 to about 1.2 mm.

28. The glass laminate structure of claim 21, wherein the glass laminate is an automotive window.

29. The glass laminate structure of claim 1 wherein the additive is used with a stabilizer selected from the group consisting of a hindered amine light stabilizers, an antioxidant, a hindered phenol, and combinations thereof.

30. The glass laminate structure of claim 11 wherein the additive is used with a stabilizer selected from the group consisting of a hindered amine light stabilizers, an antioxidant, a hindered phenol, and combinations thereof.

31. The glass laminate structure of claim 21 wherein the additive is used with a stabilizer selected from the group consisting of a hindered amine light stabilizers, an antioxidant, a hindered phenol, and combinations thereof.
